(19) United States
(12) Patent Application Publication
(10) Pub. No.: US 2021/0150001 A1
(43) Pub. Date: May 20, 2021

(54) ADAPTIVE PENALTY TERM DETERMINATIONS IN APPLICATIONS OF QUANTUM COMPUTING TO ELECTRONIC DESIGN AUTOMATION PROCESSES

(71) Applicant: Mentor Graphics Corporation, Wilsonville, OR (US)

(72) Inventors: Fedor G. Pikus, Beaverton, OR (US); Shashank Jaiswal, West Lafayette, IN (US)

(21) Appl. No.: 16/688,028

(22) Filed: Nov. 19, 2019

(51) Int. Cl. G06F 17/50; G06N 10/00

(52) U.S. Cl. CPC G06F 17/5009; G06F 2217/12; G06N 10/00; G06F 17/5045

(57) ABSTRACT

A system may include a quantum model engine configured to generate a quantum computing model to represent an electronic design automation (EDA) process for a circuit design. The EDA process may be a multi-patterning process to assign colors to geometric elements of the circuit design, and the quantum computing model may include an objective function that specifies a cost value for a given state of the quantum computing model. Generation of the quantum computing model may include adaptively determining a penalty term in the objective function based on a circuit analysis of the circuit design. The quantum model engine may also be configured to generate a color assignment for the geometric elements of the circuit design through the quantum computing model. The system may also include a manufacture support engine configured to use the color assignment to support manufacture of circuit layers of the circuit design through multiple manufacturing steps.

### BACKGROUND

Electronic circuits, such as integrated circuits, are used in nearly every facet of modern society from automobiles to microwaves to personal computers. Design of circuits may involve many steps, known as a “design flow.” The particular steps of a design flow are often dependent upon the type of microcircuit being designed, its complexity, the design team, and the circuit fabricator or foundry that will manufacture the circuit. Electronic design automation (EDA) applications support the design and verification of circuits prior to fabrication. EDA applications may implement various EDA procedures, e.g., functions, tools, or features to analyze, test, or verify a circuit design at various stages of the design flow.

### BRIEF DESCRIPTION OF THE DRAWINGS

Certain examples are described in the following detailed description and in reference to the drawings.

FIG. 1 shows an example of a computing system that supports adaptive penalty term determinations in EDA processes.

FIG. 2 shows an example generation of a quantum computing model by a quantum model engine to support application of quantum computing to a multi-patterning process.

FIG. 3 shows an example determination of an adaptive penalty term by a quantum model engine for applications of quantum computing to multi-patterning processes.

FIG. 4 shows another example determination of an adaptive penalty term by a quantum model engine for applications of quantum computing to multi-patterning processes.

FIG. 5 shows an example of logic that a system may implement to support adaptive penalty term determinations in EDA processes.

FIG. 6 shows an example of a computing system that supports adaptive penalty term determinations in EDA processes.

### DETAILED DESCRIPTION

Modern integrated circuits continue to increase in complexity and structural density. In modern lithographic manufacturing processes, a single physical layer of an integrated circuit device can be formed using multiple manufacturing steps, e.g., via two or more separate lithographic masks. To support construction of physical layers using multiple masks, geometric elements (e.g., polygons) in layout design data representing a physical layer of an integrated circuit can be partitioned into two or more groups, which may be referred to herein as “colors.” The colors may correspond to different lithographic masks that are complementarily used to form a physical layer of the integrated circuit.

Layout design data may also be referred to as circuit layers or fabric layers. A circuit layer may include a layer of circuit components in the form of geometric elements, such as polygons, circular or elliptical shapes, or other geometric shapes. Geometric elements of a circuit layer may represent shapes that will be created (e.g. etched via lithography) in various materials/substrates to physically manufacture an integrated circuit. As such, geometric elements in a circuit layer may represent (individually or in combination) circuit components such as contacts, channels, gates, etc.

Geometric elements in a fabric layer may be colored to designate different lithographic masks that the geometric elements will be manufactured from. To illustrate, a circuit layer may include a series of closely-spaced parallel connective lines, and a multi-patterning process to color the fabric may partition different the adjacent lines such that a first of the adjacent lines is physically formed by a different lithographic mask than a second of the adjacent lines. As such, the first and second line on the same physical layer of the circuit may be physically formed in separate manufacturing steps (e.g., different lithographic processes). This technique may be referred to as “double-patterning”, as geometric elements of a circuit design may be assigned (also referred to as colored or patterned) with one of the two colors in a double-patterning scheme. In a consistent manner, techniques may divide a circuit design (or circuit layers thereof) into three sets of geometric elements, each of which may then be used to form a respective complementary lithographic mask pattern. Such a patterning process may be referred to a “triple-patterning.” The use of two, three, four, or even more complementary masks and coloring of multiple sets of geometric elements in layout design data can generally be referred to as multiple patterning or multi-patterning EDA processes.

The disclosure herein also refers to quantum computing. Quantum computing may refer to non-classical computation models that can represent quantum bits (or qubits) via quantum superpositions of possible states. Quantum computing systems may instantiate, process, configure, and process quantum computing models by leveraging quantum mechanical phenomena to manipulate qubits into different possible states. Example forms of quantum computing include quantum annealing and adiabatic quantum computations. Quantum annealing, for example, may apply quantum computing to determine a global minimum of a given objective function over a given set of candidate solutions (e.g., states in a quantum computing model), doing so via quantum fluctuations or other techniques. Developments in quantum computing are continuing, with the potential to transform computational capabilities in various different fields.

One field in which quantum computing may potentially yield benefit is in computations of EDA processes, many of which can be NP-hard problems including multi-patterning. Application of quantum computing to EDA processes, however, may present challenges to properly, efficiently, and accurately map, represent, and perform EDA computations via quantum computing. Current limitations in quantum computing systems (e.g., mapping to EDA processes, limited data precision, etc.) may further limit the effectiveness in applications of quantum computing to EDA processes.

The features described herein may support adaptive penalty term determinations in applications of quantum computing to EDA processes. In particular, the various adaptive penalty term determination features described herein may provide capabilities to adapt penalty terms in objective functions used to control quantum systems in order to account for circuit design characteristics. The adaptive penalty term determination features described herein may set interaction parameters in a quantum computing model to restrict, reduce, or altogether eliminate non-physical states in the quantum computing model. Non-physical states may represent states of the quantum computing model that cannot occur in a corresponding EDA process or are prohibited by a solution, output, parameter, or configuration of the mapped EDA process.

In applications of quantum computing to EDA processes, setting an arbitrarily large penalty parameter may be sufficient to suppress specific sets of non-physical states from being considered, traversed, computed, or otherwise output by a quantum computing system. However, setting arbitrarily large penalty parameters may reduce the accuracy of quantum computing outputs due to limited data precision capabilities in quantum computing systems, which may be limited to as few as 5-bit precision for some quantum hardware systems. Large penalty parameters may, for example, reduce the precision at which the quantum computing system can represent energy values in a quantum system, limiting the capability to determine differences between energies of a ground state and another local minimum quantum system state. In that regard, quantum systems may be unable to accurately represent or detect precise energy differences when the range of possible energies in a given quantum system vastly scales from a ground states to large energies for non-physical states, thus affecting the capability of a quantum system to output an optimal or ideal solution for quantum computing applications to EDA processes.

By adaptively determining penalty terms (and any other interaction parameters), the features described herein may address data precision limitations in modern quantum computing systems while nonetheless suppressing undesired non-physical states from being output as computation solutions. As described in greater detail herein, penalty terms in objective functions may be adaptively determined based on characteristics, heuristics, or analyzed features of input circuit designs upon which quantum computing techniques are used to perform EDA processes. In doing so, the adaptive penalty term determination features described herein may tune penalty parameters to specific circuit designs, which can yield penalty value reductions as compared to arbitrarily large penalty parameters. Such penalty term reductions and adaptations may increase the precision of energy measurements in quantum system states, which may thus improve the accuracy and effectiveness of quantum computing applications to EDA processes.

These and other adaptive penalty term determination features and technical benefits are described in greater detail herein.

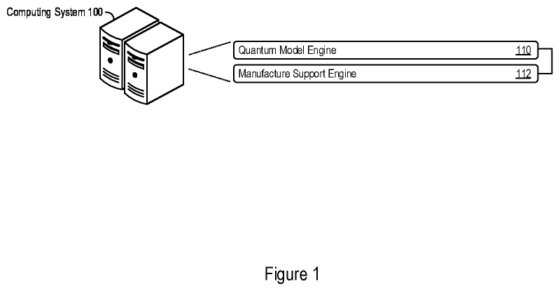

FIG. 1 shows an example of a computing system 100 that supports adaptive penalty term determinations in EDA processes. The computing system 100 may include a single or multiple computing devices such as application servers, compute nodes, data servers, desktop or laptop computers, cloud computing resources, smart phones or other mobile devices, tablet devices, embedded controllers, and more. In some implementations, the computing system 100 may takes the form of a quantum computing system that supports any number of quantum computing techniques, such as quantum annealing, adiabatic quantum computations, or others.

As described in greater detail herein, the computing system 100 may configure, form, generate, or otherwise process quantum computing models to perform EDA processes, such as multi-patterning. In that regard, the computing system 100 may generate quantum computing models that can represent or process states of a quantum system comprising particles, interaction parameters, and other characteristics to model and perform any number of corresponding EDA processes. In doing so, the computing system 100 may adaptively determine interaction parameters for the quantum system based on the specific circuit design being processed via quantum computing. Through such a circuit analysis, the computing system 100 may adaptively determine penalty parameters that can balance the suppression of non-physical states that violate solution requirements of EDA processes while also reducing penalty term values in order to increase precision of energy state measurements in the quantum system (and thus more accurately identify a ground state of the quantum system to determine the solution for the EDA process).

To implement any of the various features described herein, the computing system 100 may include a quantum model engine 110 and a manufacture support engine 112. The computing system 100 may implement the quantum model engine 110 and manufacture support engine 112 (and components thereof) in various ways, for example as hardware and programming implemented via local resources of the computing system 100. The programming for the engines 108 and 110 may take the form of processor-executable instructions stored on a non-transitory machine-readable storage medium and the hardware for the engines 108 and 110 may include a processor to execute those instructions. A processor may take the form of single processor or multi-processor systems, and in some examples, the computing system 100 implements multiple engine components or system elements using the same computing system features or hardware components (e.g., a common processor or common storage medium for the quantum model engine 110 and the manufacture support engine 112).

In operation, the quantum model engine 110 may form a quantum computing model to represent an EDA process for a circuit design, such as a multi-patterning process to assign colors to geometric elements of the circuit design. The quantum computing model may include an objective function that specifies a cost value for a given state of the quantum computing model, and the quantum model engine 110 may generate the quantum computing model by adaptively determining a penalty term in the objective function based on a circuit analysis of the circuit design. In operation, the quantum model engine 110 may also generate a color assignment for the geometric elements of the circuit design through the quantum computing model.

In operation, the manufacture support engine 112 may use the color assignment to support manufacture of circuit layers of the circuit design through multiple manufacturing steps. For example, the manufacture support engine 112 may do so by sending the color assignment to other system components to control generation of complementary lithographic masks for use in manufacturing circuit layers of the circuit design through multiple lithography steps. The color assignment may be “colored” in that it represents an explicit coloring of geometric elements of a circuit design or it may be “colorless” in indicating that coloring solution for a multi-patterning process on a circuit design exists (or conversely, does not exist). The manufacture support engine 112 may use (e.g., send) color assignments whether in a colored form or a colorless form to support manufacture of circuit designs.

These and other example adaptive penalty term determination features according to the present disclosure are described in greater detail next. Many of the examples presented herein are provided with respect to multi-patterning EDA processes. However, the adaptive penalty term determination features described herein may be consistently applied for any number of additional or alternative EDA processes, such as design-rule-check (DRC) processes, optical proximity correction (OPC) processes, design-for-manufacture (DFM), and many more.

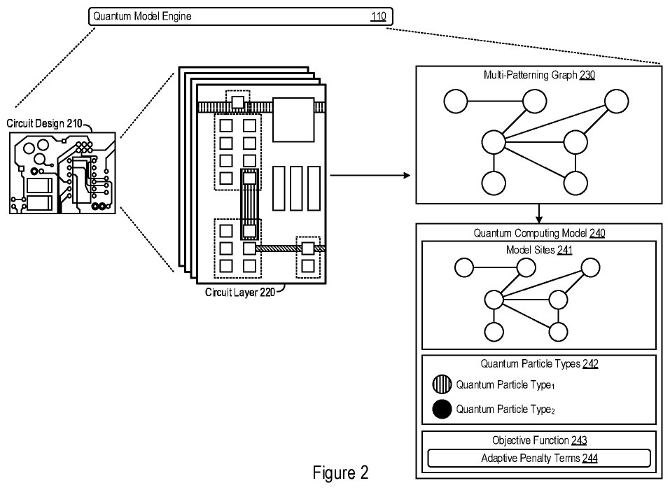

FIG. 2 shows an example generation of a quantum computing model by a quantum model engine 110 to support application of quantum computing to a multi-patterning process. In doing so, the quantum model engine 110 may access a circuit design, which may include multiple circuit layers to color via multi-patterning. In the example shown in FIG. 2, the quantum model engine 110 accesses the circuit design 210 which includes the circuit layer 220.

The quantum model engine 110 may construct a multi-patterning graph for a given layer of a circuit design, such as the multi-patterning graph 230 constructed for the circuit layer 220. To generate the multi-patterning graph 230, the quantum model engine 110 may represent geometric elements in the circuit layer 220 as nodes and any color constraints between geometric elements of the circuit layer 220 as edges, for example according to any number of modern multi-patterning graph generation techniques and methodologies.

In supporting applications of quantum computing to EDA processes, the quantum model engine 110 may generate a quantum computing model, which may include loading or instantiating a previously generated quantum computing model with any of the parameters, characteristics, or features described herein. In some instances, the quantum model engine 110 may map a multi-patterning EDA process to a quantum computing system. The quantum model engine 110 may generate (e.g., load or instantiate) a quantum computing model with quantum particles and interaction parameters that map to a given multi-patterning process or other EDA process. In some examples, the quantum model engine 110 may do so by mapping the multi-patterning graph 230 to a quantum computing model 240. The quantum computing model 240 may include model sites 241 that represent locations in the quantum computing model 240 that quantum particles of the quantum computing model 240 can occupy. Each given model site among the model sites 241 may correspond to a particular geometric element of a circuit layer 220 (and thus, a given node in the multi-patterning graph 230).

The quantum model engine 110 may generate a quantum computing model 240 that defines any number of quantum particle types 242, and the number of different quantum particle types may depend on the number of colors used for the multi-patterning process (e.g., double-patterning processes, triple-patterning processes, etc.). The quantum particle types 242 may further define characteristics, properties, or parameters of the quantum particles, and may thus provide a basis in the definition of the various quantum particle types that exist in the quantum computing model 240. The quantum computing model 240 generated by the quantum model engine 110 may also include an objective function 243 through which the quantum model engine 110 may evaluate states in the quantum computing model 240 and perform the multi-patterning EDA process via quantum computing.

The objective function 243 may, in effect, control how a quantum system behaves and may thus include any number of interaction parameters to control behavior of a quantum system. Put another way, the objective function 243 may be configured by the quantum model engine 110 to specifically model attributes, goals, computations, or behavior of an EDA process, e.g., by representing the EDA process as an optimization problem to be processed or solved via quantum computing. As described herein, the quantum model engine 110 may determine any number of adaptive penalty parameters 244 for the objective function 243, and the adaptive penalty parameters 244 may be determined based on an analysis of circuit design 210 or selected components thereof (such as the circuit layer 220).

The specific form of the quantum computing model 240 (including the objective function 243) generated (e.g., loaded) by the quantum model engine 110 may vary based on the type of quantum computing techniques to be applied, capabilities (or limitations) of a given quantum computing system, or various other quantum-specific factors. For instance, the quantum model engine 110 may generate the quantum computing model 240 (or components thereof) in a manner or form specifically suited for quantum annealing, adiabatic quantum algorithms, and the like.

To illustrate, the quantum model engine 110 may represent the multi-patterning graph 230 (whether expressly or logically) as a graph G(V,E) with n number of nodes or vertices V={v₁, . . . , vₙ}, m number of edges E={e₁, . . . eₘ}, and k number of colors C={c₁, . . . , cₖ}. In such examples, k=2 for a double-patterning process, k=3 for a triple-patterning process, etc. For such a graph g(V,E), the quantum model engine 110 may represent an adjacency matrix a, in which aᵢⱼ, and where i,j∈{1, . . . , n}. For each cell aᵢⱼ of the adjacency matrix a:

$${a}_{ij} = \{ \begin{matrix}1 if there ' s an edge between {v}_{i} and {v}_{j} \\ 0 otherwise\end{matrix}$$

In some examples, the quantum model engine 110 may also determine or identify a degree d of a given node as the sum of the cell values of a given row or column corresponding to the node, e.g., as dᵢ=Σⱼaᵢⱼ.

For multi-patterning EDA processes, the quantum model engine 110 may perform a coloring process by associating a color c with each node, e.g., in which xᵢ^{(c)}, i∈V. In doing so, the quantum model engine 110 may define a set of indicator functions as follows:

$${∀}_{i} {f}_{{ij}_{1}} = \{ \begin{matrix}{a}_{{ij}_{1}} if {x}_{i}^{( c )} \neq {x}_{{j}_{1}}^{( c )} \\ 0 otherwise\end{matrix} \\ ⋮ \\ {∀}_{i} {f}_{{ij}_{1} {j}_{2} … {j}_{t}} = \{ \begin{matrix}{a}_{{ij}_{1}} {a}_{{j}_{1} {j}_{2}} … {a}_{{j}_{t - 1} {j}_{t}} if {x}_{i}^{( c )} \neq ⋯ \neq {x}_{{j}_{t}}^{( c )} \\ 0 otherwise\end{matrix}$$

Through these indicator functions, the quantum model engine 110 may represent the objective of the multi-patterning EDA process as follows: to assign vᵢ, i∈V, a value from the set C (e.g., a color) such that, for given (relatively small) integers t and k, the initial t−1 conditions of the set of indicator functions may or may not hold, but ensure that the t^{th} condition of the indicator functions must hold. That is, the quantum model engine 110 may express the objective of such a constrained coloring or multi-patterning process to maximize the following cost function:

$${\sum }_{{ij}_{1} {j}_{2} … {j}_{t}} {f}_{{ij}_{1} {j}_{2} … {j}_{t}}$$

While the cost function above may provide one representation to perform a multi-patterning process, such a cost function may be inapplicable to, incompatible with, or unsupported by various quantum computing systems. As such, the quantum model engine 110 may transform the above cost function (or any other cost function representative of an EDA process) into a form supported via quantum computing.

In some examples, the quantum model engine 110 may transform cost functions of EDA processes into a form supported by adiabatic quantum algorithms or quantum annealing. Examples of function forms supported by quantum computing systems include stoquastic Hamiltonians or Quadratic Unconstrained Binary Optimization (QUBO) problems, such as QUBO cost functions in the following form:

$$C ( x ) = C ( {x}_{1} , … , {x}_{N} ) = {\sum }_{i} {h}_{i} {x}_{i} + {\sum }_{i , j} {J}_{i , j} {x}_{i} {x}_{j}$$

In the QUBO cost function C(x) above, the terms hᵢ, J_{i,j} may represent real coefficients and x∈{0,1}ⁿ may represent a vector of binary-valued variables. As such, the quantum model engine 110 may map a multi-patterning cost function (or any other cost function for other EDA processes) to a QUBO form in order to solve or perform the EDA process via quantum annealing. As a particular example, the quantum model engine 110 may represent the cost function of a multi-patterning or other EDA process in a Hamiltonian matrix in Ising form, e.g., as the following:

$${E}_{Ising} ( {s}_{1} , … , {s}_{N} ) = {\sum }_{i}^{N} {h}_{i}^{′} {s}_{i} + {\sum }_{i ( i , j ) ∈ ɛ} {J}_{i , j}^{′} {s}_{i} {s}_{j}$$

where sᵢ=±1. The quantum model engine 110 may use a mapping of sⱼ=2xⱼ−1 to relate an Ising Hamiltonian to the form of the QUBO cost function C(x) described herein. The QUBO form (or Hamiltonian Ising) may be the form of the objective function 243 generated by the quantum model engine 110 to model a corresponding multi-patterning process.

By mapping a multi-patterning or other EDA process to a quantum computing model, the quantum model engine 110 may support application of quantum computing (e.g., quantum annealing) to EDA processes. In using quantum computing to solve Ising problems (and thus perform EDA processes), the quantum model engine 110 may support adiabatic quantum optimizations or quantum annealing. In such examples, the quantum model engine 110 may perform the EDA process (e.g., determine a color assignment for a multi-patterning process) as the solution of a combinatorial problem that can be encoded in ground state of a Hamiltonian H_{C}. The quantum model engine 110 may construct a time-dependent Hamiltonian H=(1−s)H_{B}+s H_{C}, in which s=t/t_{f}, t_{f} is a total evolution time (which can be a tunable parameter), and H_{B} is a Hamiltonian with a ground state that defines the initial state of a quantum system defined by the quantum computing model. The quantum model engine 110 may start from s=0 and adiabatically evolve the quantum system to the final state Hₛ, where s=1, with a sufficiently large value of t_{f}. For any Ising Hamiltonian or quantum annealing problem, the quantum model engine 110 may generate the quantum computing model 240 to identify three components H_{B}, H_{C} and evolution path.

In some examples, the ground state of the quantum system may be identified by the quantum model engine 110 as a state of the quantum system with a minimum cost value for the quantum computing model, e.g., as specified through the objective function 243 in a QUBO form. That is, the objective function 243 may specify a cost value for a given state of the quantum computing model 240, and adiabatic evolution of the quantum system may identify different system states with different cost values as measured through the objective function 243. By determining the ground state via the quantum computing model 240 (and the quantum system defined by the quantum computing model 240), the quantum model engine 110 may apply quantum computing techniques to perform EDA processes such as multi-patterning.

In some multi-patterning examples presented herein and any other corresponding quantum computing models, the quantum model engine 110 may set penalty terms (or other interaction parameters) in objective functions to limit, suppress, or reduce non-physical states of the quantum system. Non-physical states of a quantum computing model may refer to corresponding states of the EDA process that are impossible, inaccurate, inapplicable, or violate a solution requirement of the EDA process. As one multi-patterning example, the quantum model engine 110 may adaptively set penalty parameters to prohibit a non-physical state of the quantum computing model in which two quantum particles occupy a same model site. This may be a state that cannot occur in a(n optimal) solution or output of a multi-patterning process, as a particular geometric element in a circuit layer cannot be colored with two or more colors. Accordingly, the quantum model engine 110 may define interaction parameters in an objective function to apply an exclusionary principle similar to electron atom states in which no two electrons can occupy the same location in the atomic system.

As another example, the quantum model engine 110 may adaptively set penalty parameters in an objective function to deter void model sites (e.g., without a quantum particle occupying the model site). That is, in some examples, non-physical states prohibited by penalty parameters adaptively determined by the quantum model engine 110 include those in which a quantum particle does not occupy a model site. In some quantum computing models generated for multi-patterning EDA processes, the correspondence of colors to quantum particle types may be at least 1:1 ratio, in that each color of the multi-patterning process is represented by at least one quantum particle type of the quantum computing model. A state of such a quantum system in which a model site is not occupied by any quantum particle (e.g., is void) would represent a multi-patterning color assignment in which a given geometric element corresponding to the model site is not assigned a color.

Since such a color assignment would represent an erroneous or incorrect output for the multi-patterning process or violate a solution requirement for the multi-patterning process, the quantum model engine 110 may suppress or prohibit corresponding non-physical states from the quantum computing model via penalty terms or interaction parameters. Put another way, the quantum model engine 110 may prohibit non-physical states via adaptive penalty term determinations that would effectively violate EDA process solution requirements of a mapped EDA process. Accordingly, the quantum model engine 110 may set penalty terms and other interaction parameters to suppress non-physical states that result in EDA process violations, such as multi-patterning violations in which a geometric element in the circuit layer is not assigned any color or colored with two different colors.

To further illustrate, the quantum model engine 110 may map a multi-patterning EDA process to a quantum computing system that supports quantum annealing or adiabatic quantum optimization. For a circuit design with n number of geometric elements and a k-color multi-patterning EDA process, the quantum model engine 110 may construct a multi-patterning graph with n number of vertices and k number of colors for assignment. In doing so, the quantum model engine 110 may represent k*n binary variables, referred to herein as xᵢ^{(c)}, in which xᵢ^{(c)}=1 means that a vertex i is colored with color c, and xᵢ^{(c)}=0 means it is not.

The quantum model engine 110 may construct a cost function in the form of a general Polynomial Unconstrained Binary Optimization (PUBO) that includes two different types of penalty terms that correspond to different constraints of the multi-patterning process. In a first constraint of the PUBO form cost function, the quantum model engine 110 may set a penalty term such that each vertex must be colored by one, and no more than one color. For each vertex i, the quantum model engine 110 may set the following penalty term P₁:

$$\begin{matrix}{P}_{1} = {( 1 - {\sum }_{c} {x}_{i}^{( c )} )}^{2} \\ = 1 + {( {\sum }_{c} {x}_{i}^{( c )} )}^{2} - 2 {\sum }_{c} {x}_{i}^{( c )} \\ = 1 + ( {\sum }_{{c}^{′}} {\sum }_{c} {x}_{i}^{( c )} {x}_{i}^{( {c}^{′} )} ) - 2 {\sum }_{c} {x}_{i}^{( c )} \\ = 1 + ( {\sum }_{c} {x}_{i}^{( c )} {x}_{i}^{( c )} + 2 {\sum }_{{c}^{′}} {\sum }_{c < {c}^{′}} {x}_{i}^{( c )} {x}_{i}^{( {c}^{′} )} ) - 2 {\sum }_{c} {x}_{i}^{( c )} \\ = 1 + ( {\sum }_{{c}^{′}} {x}_{i}^{( c )} + 2 {\sum }_{{c}^{′}} {\sum }_{c < {c}^{′}} {x}_{i}^{( c )} {x}_{i}^{( {c}^{′} )} ) - 2 {\sum }_{c} {x}_{i}^{( c )} \\ = 1 - {\sum }_{c} {x}_{i}^{( c )} + 2 {\sum }_{{c}^{′}} {\sum }_{c < {c}^{′}} {x}_{i}^{( c )} {x}_{i}^{( {c}^{′} )} \\ = - {\sum }_{c} {x}_{i}^{( c )} + 2 {\sum }_{{c}^{′}} {\sum }_{c < {c}^{′}} {x}_{i}^{( c )} {x}_{i}^{( {c}^{′} )}\end{matrix}$$

For a second constraint, the quantum model engine 110 may set a penalty term such that T-vertices in-a-row cannot be colored with the same color. The term T may thus be a coloring parameter of the multi-patterning process, specifying a number of consecutively colored geometric elements (in essence, color violations) that are permitted in the multi-patterning process. In configuring this second constraint, the quantum model engine 110 may set such a penalty term P₂ for each vertex i:

$${P}_{2}^{( T )} = {\sum }_{t = 1}^{T} [ {α}_{t} {\sum }_{{j}_{1} … {j}_{t}} ( {\sum }_{c} {x}_{i}^{( c )} {a}_{{ij}_{1}} \cdot {\prod }_{m = 1}^{t} {x}_{{j}_{m}}^{( c )} \cdot {\sum }_{r = 2}^{t} {a}_{{j}_{r - 1} {j}_{r}} ) ]$$

where α={α₁, . . . , α_{T}} are tunable parameters which affect the relative energy scales of both penalties and therefore the Hamiltonian evolution of the quantum system. These parameters α may be adaptively determined by the quantum model engine 110 based specifically on analysis of the circuit design upon which the quantum computing is applied, and may thus be included as part of the adaptive penalty terms 244 of an objective function 243 determined by the quantum model engine 110.

Altogether, the quantum model engine 110 may represent a PUBO cost function for a general T-consecutive node constraint k-coloring as:

$${C}^{( T )} ( x ) = {\sum }_{i = 1}^{n} [ {P}_{1} + {P}_{2}^{( T )} ] .$$

As such, the optimization objective determined by the quantum model engine 110 for a given circuit design may then be represented as:

min C^{(T)}(x)

The form above may be analogous to the indicator function-based cost function described herein, which the quantum model engine 110 may convert into a QUBO form applicable to or supported by quantum computing systems (e.g., quantum annealers).

In some examples, the quantum model engine 110 may transform a PUBO cost function into a QUBO cost function by introducing auxiliary variables. For a multi-patterning process in which T=2, the quantum model engine 110 may set the corresponding PUBO objective function as:

$${C}^{( 2 )} ( x ) = {\sum }_{i = 1}^{n} [ {P}_{1} + ( {α}_{1} {\sum }_{{j}_{1}} {\sum }_{c} {x}_{i}^{( c )} {x}_{{j}_{1}}^{( c )} {a}_{{ij}_{1}} ) + ( {α}_{2} {\sum }_{c} {\sum }_{{j}_{1} , {j}_{2}} {x}_{i}^{( c )} {x}_{{j}_{1}}^{( c )} {x}_{{j}_{2}}^{( c )} {a}_{{ij}_{1}} {a}_{{j}_{1} {j}_{2}} ) ]$$

The quantum model engine 110 may set α₂=0, which may allow for 2-colors in-a-row defects in a color assignment (e.g., T=2), since, for a given c, the third term in the above PUBO objective function is zero if any one of the three binary variables xᵢ^{(c)}, xⱼ_{₁}^{(c)}, xⱼ_{₂}^{(c)} are zero. Accordingly, at a given color c, the quantum model engine 110 may determine no penalty if any two of the three variables have a unit value, i.e., they form the two nodes of a monochromatic edge. When α₂≠0, the cost function would favor a coloring with minimum number of monochromatic edges.

In PUBO-QUBO conversions performed by the quantum model engine 110, the quantum model engine 110 may simplify higher-order terms. To illustrate, the third term of the example PUBO objective function above includes a cubic term xᵢ^{(c)}, xⱼ_{₁}^{(c)}, xⱼ_{₂}^{(c)}. To map this cubic term to the QUBO form, the quantum model engine 110 may introduce an auxiliary variable \hat{x}ⱼ_{₁}_{,j}_{₂}^{(c)}=xⱼ_{₁}^{(c)}xⱼ_{₂}^{(c)}, and a penalty (\hat{x}ⱼ_{₁}_{,j}_{₂}^{(c)}−xⱼ_{₁}^{(c)}xⱼ_{₂}^{(c)})². Using this auxiliary variable, the PUBO objective function above can be represented by the quantum model engine 100 in a simplified function form as:

$${C}^{( 2 )} ( x ) = {\sum }_{i = 1}^{n} [ {P}_{1} + ( {α}_{1} {\sum }_{{j}_{1}} {\sum }_{c} {x}_{i}^{( c )} {x}_{{j}_{1}}^{( c )} {a}_{{ij}_{1}} ) + ( {α}_{2} \{ {\sum }_{c} {\sum }_{{j}_{1} , {j}_{2}} {x}_{i}^{c} {\hat{x}}_{{j}_{1} , {j}_{2}}^{( c )} {a}_{{ij}_{1}} {a}_{{j}_{1} {j}_{2}} + {\sum }_{c} {\sum }_{{j}_{1} , {j}_{2}} {( {\hat{x}}_{{j}_{1} , {j}_{2}}^{( c )} - {x}_{{j}_{1}}^{( c )} , {x}_{{j}_{2}}^{( c )} )}^{2} {a}_{{j}_{1} {j}_{2}} \} ) ]$$

This simplified function form may be in the QUBO form consistent with or applicable to quantum computing systems, and may thus be used to map an EDA function to a QUBO form for application of quantum computing to EDA processes. In a consistent manner, the quantum model engine 110 may simplify higher order polynomials. Note that for a d+2 degree polynomial, the quantum model engine 110 may introduce O(d) auxiliary variables.

With a generated quantum computing model, the quantum model engine 110 may apply quantum computing to perform an EDA process. In some examples, the quantum model engine 110 may apply quantum annealing or adiabatic quantum optimizations to determine a ground state of the quantum computing model 240 (and represented quantum system). The ground state may represent a solution or output of the EDA process, determined through mapping the EDA process to a quantum computing system. For a multi-patterning EDA process, a determined ground state from the quantum computing model may include quantum particles (corresponding to multi-patterning colors) at specific model sites (corresponding to geometric elements of a circuit design). As such, a computed ground state may represent a color assignment to apply to geometric elements of a circuit design. In determining the color assignment, the adaptive penalty term determinations may reduce or eliminate consideration of states that could not be part of the solution (and thus color assignment) to the multi-patterning process.

Turning to adaptive penalty term determinations in greater detail, modern quantum computing systems can have data limitations that can reduce the range or precision of numerical values that can be represented in a quantum system. For a quantum system with 5-bit data precision, for example, such a quantum system may only be able to represent 32 different binary values and large numerical ranges equally spaced into 32 increments may result in large value gaps when the range of energy values in a modeled quantum system ranges from a ground state (e.g., 0 energy) to large energy values for non-physical states (e.g., 999,999+ energy). Using arbitrarily large penalty parameters in objective functions to suppress non-physical states, while effective in eliminating non-physical states from consideration in a quantum system, can result in precision loss and inaccurate results (e.g., being unable to distinguish between a true ground state of the quantum system as opposed to local minima, and thus unable to find an optimal solution to a mapped EDA process). Adaptive determination of penalty terms may be used by the quantum model engine 110 suppress, limit, reduce, or eliminate non-physical states while reducing precision loss or state distortion that may be present when using excessively high penalty terms.

In some examples, adaptively penalty terms determined by the quantum model engine 110 may suppress some, but not all, non-physical states from occurring in the quantum computing model, wherein the non-physical states correspond to outputs to the multi-patterning process that represent prohibited solutions of the multi-patterning process. Such prohibited solutions of the multi-patterning process may include outputs in which a geometric element is assigned more than one color, a geometric element is assigned no color, or combinations of both

In adaptively determining penalty terms in quantum computing applications to EDA processes, the quantum model engine 110 may tune penalty terms to balance accurate determination of quantum ground states (and thus optimal solutions to EDA processes) with suppression of non-physical states from being considered or output by generated quantum computing models. As an “ideal” or “optimal” penalty term cannot be known without respect to a particular optimization problem (or corresponding input circuit design), the quantum model engine 110 may tune penalty terms used in quantum objective functions to be specific to input circuit designs. By analyzing circuit designs, the quantum model engine 110 may determine specific characteristics or parameters of a corresponding optimization problem in which penalty parameters can be adapted, tuned, and determined to support increased quantum computing precision while also maintaining accurate suppression of unwanted results (e.g., suppressing non-physical states).

One example configuration in which the quantum model engine 110 may apply quantum computing to multi-patterning or other EDA processes is via quantum annealing and adiabatic quantum optimizations. In such techniques, the quantum model engine 110 may generate quantum computing models and corresponding objective functions in which a ground state of a mapped quantum system represents an optimal solution to the EDA process. Such a ground state may be characterized, configured, or defined in the quantum system with a ground energy of 0.

Violation of constraints in the quantum system may incur energy, and in a multi-patterning example, mono-chromatic edges (e.g., quantum particles occupying neighboring model sites) may incur an energy penalty. In some examples, a color constraint violation may be assigned a penalty of +1 energy. Thus, a quantum system may require fine precision in order to differentiate between an optimal solution (ground state with 0 energy) and another quantum system state with only a single color constraint violation (+1 energy). In some cases, the quantum model engine 110 may evolve a quantum computing model through various states, including quantum system states with high energy (e.g., a worst-case scenario in which all nodes violate color constraints). As can be seen, the highest possible quantum energy a mapped quantum system can reach may be dependent on the optimization problem and input multi-patterning graph, which may in turn depend on the specific circuit design being analyzed. Further complicating the issue, for some multi-patterning problems (e.g., for complex circuit designs), an optimal solution and corresponding ground state with 0 energy may not even exist.

To adaptively determine penalty terms for applications of quantum computing, the quantum model engine 110 may analyze an input circuit design or components thereof to tune penalty terms and interaction parameters in a quantum system. In the example shown in FIG. 2, the quantum model engine 110 may analyze the circuit layer 220, e.g., as represented via the multi-patterning graph 230 in order to determine the adaptive penalty terms 244 of the objective function 243. In analyzing circuit designs, the quantum model engine 110 may tune penalty terms or parameters to allow for a quantum system to enter non-physical states during system evolution (e.g., during adiabatic optimizations), so long as the adaptive penalty terms do not return non-physical states as a quantum computing output by trapping the quantum system evolution upon entering non-physical states.

Explained in a different way, the quantum model engine 110 may tune the adaptive penalty terms 244 such that quantum system evolutions can occur in a represented range of energies (as limited by upper bounds set by or dependent upon the adaptive penalty terms 244 and data precision of a quantum computing system), but also in a manner to prevent returning such non-physical states as quantum computing outputs for a mapped EDA process. The quantum model engine 110 may do so by determining adapted penalty parameters at less than arbitrarily high energy levels that effectively prohibit a modeled quantum system from entering such non-physical states, e.g., at lesser energy values than a worst-case scenario for constraint violations of a multi-patterning EDA process.

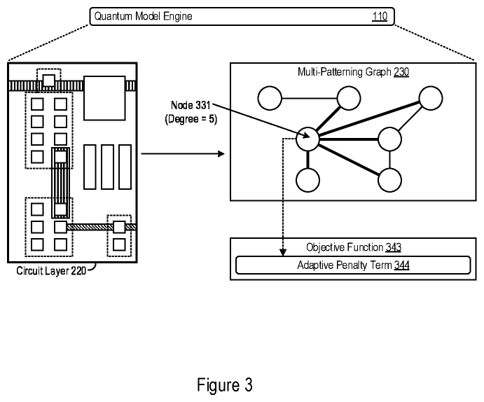

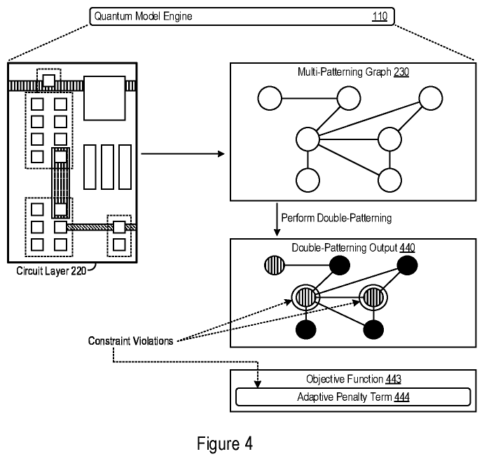

Some example circuit analyses and penalty parameter determinations are described in greater detail next in connection with FIGS. 3 and 4.

FIG. 3 shows an example determination of an adaptive penalty term by the quantum model engine 110 for applications of quantum computing to multi-patterning processes. In some implementations, the quantum model engine 110 may analyze a circuit design to determine a heuristic by which to adaptively set penalty terms in objective functions. Such a circuit analysis may drive adaptive penalty term determinations based on circuit size, number of color constraints, node degrees, or other graph or circuit parameters determined through circuit analysis.

As a particular example, the quantum model engine 110 may identify a given geometric element in a circuit design with a highest number of coloring constraints to other geometric elements in the circuit design and set a penalty term in the objective function to be proportional to the highest number of coloring constraints for the given geometric element. To do so, the quantum model engine 110 may adaptively set penalty terms as a function of the highest number of coloring constraints, e.g., as directly proportional via factor (0.25, 1.25, 0.5, 0.9 or any other configurable ratio), via energy offsets (+2, −3, +5, etc.), or combinations of both.

To illustrate through FIG. 3, the quantum model engine 110 may perform a circuit analysis on the circuit layer 220 to adaptively determine penalty terms for a mapped EDA process for the circuit layer 220. In doing so, the quantum model engine 110 may construct the multi-patterning graph 230 and perform the circuit analysis through an analysis of the multi-patterning graph 230 (which, in effect, is another representation of the circuit layer 220 specific to a multi-patterning EDA process). For instance, the quantum model engine 110 may traverse the multi-patterning graph 230 to determine a node with the highest degree d, an average degree of nodes in the multi-patterning graph 230, or any other analysis value for the multi-patterning graph 230. Then, the quantum model engine 110 may configure an objective function 343 for the circuit layer 220 (e.g., in QUBO form as described herein) and doing so by adaptively setting the adaptive penalty term 344 to be proportional to the highest degree d determined via the circuit analysis of the circuit layer 220. In the particular example shown in FIG. 3, the quantum model engine 110 may determine the highest degree d among geometric elements of the circuit layer 220 to have a value of 5, and set the adaptive penalty term 344 accordingly (e.g., as a penalty value of 5 equal to the highest degree d, as another proportion thereof, with additional or alternative offsets, etc.).

Accordingly, the quantum model engine 110 may adaptively set penalty terms in an objective function based on specific circuit characteristics of an input circuit design. As another example, the quantum model engine 110 may analyze an input circuit design via constraint relaxations, which is described next in connection with FIG. 4.

FIG. 4 shows another example determination of an adaptive penalty term by the quantum model engine 110 for applications of quantum computing to multi-patterning processes. In some implementations, the quantum model engine 110 may analyze a circuit design by solving a subset or less complex version of an optimization problem represented by the circuit design and/or EDA process.

For multi-patterning EDA processes, the quantum model engine 110 may relax at least some coloring constraints of the multi-patterning process and compute an output for the relaxed multi-patterning process performed on the circuit design. Relaxed constraints may include removing a selected number of coloring constraints (e.g., by removing edges from a multi-patterning graph). As another example, constraint relaxation by the quantum model engine 110 may include increasing violation thresholds for the multi-patterning process (e.g., increasing a T parameter value from 3 to 4 to permit 4 consecutive nodes (but not 5 consecutive) from being colored with the same color, increased from 3 consecutive nodes (but not 4 consecutive). Then, the quantum model engine 110 may set penalty terms in an objective function to be proportional to (e.g., as a function of) a number of constraint violations in the computed output for the relaxed multi-patterning process performed on the circuit design.

In some examples, the quantum model engine 110 may relax constraints for circuit analysis by performing a multi-patterning process of lower degree. In the particular example shown in FIG. 4, the quantum model engine 110 may generate a quantum computing model to apply quantum computing to a triple-patterning process for the circuit layer 220. In doing so, the quantum model engine 110 may construct the multi-patterning graph 230 and analyze the circuit layer 220 via the multi-patterning graph 230 to adaptively determine penalty terms. In analyzing the circuit layer 220, the quantum model engine 110 may perform a double-patterning process on the circuit layer 220 and determine a number of constraint violations in an output of the double-patterning process on the circuit layer 220.

As double-patterning EDA processes can be computed in linear time, such a relaxed EDA process computation may be performed relatively quickly and provide a heuristic by which the quantum model engine 110 can adaptively set penalty terms for a quantum computing model. Relaxed constraints (such as double-patterning) may allow the quantum model engine 110 to analyze a circuit design and determine a possible solution for the EDA process, and do so in a relatively quicker and more efficient manner. Such outputs may not represent an ideal solution to an EDA process, but may provide a heuristic by which the quantum model engine 110 can set penalty terms to balance accuracy and data precision.

To explain further, the quantum model engine 110 may compute the double-patterning output 440 In FIG. 4, which may take the form of a 2-color assignment for the circuit layer 220. The 2-color assignment may represent a possible solution to the triple-patterning EDA process for the circuit layer 220, as a 2-color assignment can always be a possible solution for a triple-patterning process. Moreover, the 2-color assignment may be non-optimal, as the quantum model engine 110 could potentially reassign a color of a given node on a monochromatic edge with the third color, thus improving the 2-color assignment for the triple-patterning EDA process by removing at least one color constraint violation. As such, the double-patterning output 440 may represent a non-ideal solution that a quantum system may further evolve from into a ground state, and the quantum model engine 110 may adapt penalty terms in an objective function 443 for a triple-patterning process accordingly. In particular, the quantum model engine 110 may set the adaptive penalty term 444 in the objective function 443 to be proportional to the number of constraint violations in the double-patterning output 440 of the double-patterning process performed on the circuit layer 220. The constraint violations may represent an energy penalty for a subset of the triple-patterning process, which may be sufficiently high to deter non-ideal states that the quantum system can evolve from, but sufficiently low to increase data precision in quantum energy representations.

In some instances, the quantum model engine 110 may apply constraint relaxations and determine number of constraint violations for EDA processes performed on the relaxed constraint circuit designs. Doing so may provide a “worst-case” scenario in which the quantum model engine 110 may proportionally adapt penalty terms for. In adaptively setting penalty terms, the quantum model engine 110 may set penalty terms as directly proportional to a number of constraint violations for a relaxed multi-patterning process (or other EDA process), e.g., based a determined ratio such as 0.25 or 0.5. Additionally or alternatively, the quantum model engine 110 may offset a determined number of constraint violations by a predetermined energy offset (e.g., −2 energy), and set the penalty terms accordingly.

As such, the quantum model engine 110 may adaptively determine penalty terms (or any other interaction parameters) for a quantum computing model based on a circuit analysis of input circuit designs. In doing so, the quantum model engine 110 may adaptively set penalty values for given circuit designs and multi-patterning parameters. These adaptive penalty term determination features may improve (e.g., maximize) quantum data precision (which may be hardware limited) while continuing to suppress or otherwise prohibit non-physical state solutions for EDA processes. As such, the features described herein may improve the efficiency and accuracy of quantum computing applications to EDA processes.

In the various ways described herein, computing systems may support adaptive penalty term determinations for applications of quantum computing to EDA processes. Any of the features described herein may be implemented individually or in combination with any of the features described in U.S. patent application Ser. No. ______, filed by Mentor Graphics Corporation on Nov. 19, 2019 and titled “LIMITED BASIS QUANTUM PARTICLE DEFINITIONS IN APPLICATIONS OF QUANTUM COMPUTING TO ELECTRONIC DESIGN AUTOMATION PROCESSES”, the entirety of which is incorporated by reference herein. For instance, the quantum model engine 110 may implement, provide, or support any of the limited basis quantum particle definition features described therein by the incorporated reference, any of the adaptive penalty term determination features described herein by the present disclosure, or any combinations of both.

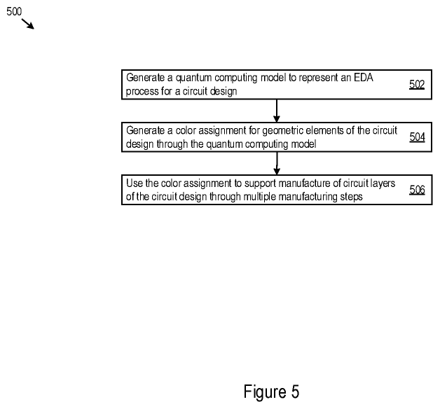

FIG. 5 shows an example of logic 500 that a system may implement to support adaptive penalty term determinations in EDA processes. In some examples, the computing system 100 may implement the logic 500 as hardware, executable instructions stored on a machine-readable medium, or as a combination of both. The computing system 100 may implement the logic 500 via the quantum model engine 110 and the manufacture support engine 112, for example, through which the computing system 100 may perform or execute the logic 500 as a method to support adaptive penalty term determinations in EDA processes. However, other implementation options are possible.

In implementing the logic 500, the quantum model engine 110 may generate a quantum computing model to represent an EDA process (502), and the EDA process may be a multi-patterning process to assign colors to geometric elements of the circuit design. The quantum computing model generated by the quantum model engine 110 may include an objective function that specifies a cost value for a given state of the quantum computing model. As, generating the quantum computing model by the quantum model engine 110 may include adaptively determining a penalty term in the objective function based on a circuit analysis of the circuit design. In implementing the logic 500, the quantum model engine 110 may also generate a color assignment for the geometric elements of the circuit design through the quantum computing model (504). In implementing the logic 500, the manufacture support engine 112 may use the color assignment to support manufacture of circuit layers of the circuit design through multiple manufacturing steps (506).

While example features are shown and described through FIG. 5, the logic 500 may include any number of additional or alternative steps as well. The logic 500 may additionally or alternatively implement any other features described herein, for example any number of features with respect to the quantum model engine 110, manufacture support engine 112, or combinations of both.

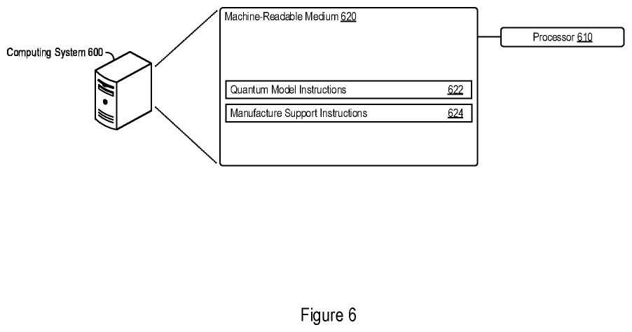

FIG. 6 shows an example of a computing system 600 that supports adaptive penalty term determinations in EDA processes. The computing system 600 may include a processor 610, which may take the form of a single processor or multiple processors. The processor(s) 610 may include a central processing unit (CPU), microprocessor, or any hardware device suitable for executing instructions stored on a machine-readable medium. The computing system 600 may include a machine-readable medium 620. The machine-readable medium 620 may take the form of any non-transitory electronic, magnetic, optical, or other physical storage device that stores executable instructions, such as the quantum model instructions 622 and manufacture support instructions 624 shown in FIG. 6. As such, the machine-readable medium 620 may be, for example, random access memory (RAM) such as a dynamic RAM (DRAM), flash memory, spin-transfer torque memory, an electrically-erasable programmable read-only memory (EEPROM), a storage drive, an optical disk, and the like.

The computing system 600 may execute instructions stored on the machine-readable medium 620 through the processor 610. Executing the instructions may cause the computing system 600 to perform any of the adaptive penalty term determination features described herein, including according to any of the features of the quantum model engine 110, the manufacture support engine 112, or combinations of both.

For example, execution of the quantum model instructions 622 by the processor 610 may cause the computing system 600 to generate a quantum computing model to represent an EDA process, and the EDA process may be a multi-patterning process to assign colors to geometric elements of the circuit design. The quantum computing model generated by the quantum model engine 110 may include an objective function that specifies a cost value for a given state of the quantum computing model. As such generating the quantum computing model by the computing system 600 through execution of the quantum model instructions 622 may include adaptively determining a penalty term in the objective function based on a circuit analysis of the circuit design. Execution of the quantum model instructions 622 by the processor 610 may further cause the computing system 600 to generate a color assignment for the geometric elements of the circuit design through the quantum computing model. Execution of the manufacture support instructions 624 may cause the computing system 600 to use the color assignment to support manufacture of circuit layers of the circuit design through multiple manufacturing steps.

The systems, methods, devices, and logic described above, including the quantum model engine 110 and the manufacture support engine 112, may be implemented in many different ways in many different combinations of hardware, logic, circuitry, and executable instructions stored on a machine-readable medium. For example, the quantum model engine 110, manufacture support engine 112, or both, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above, including according to any features of the quantum model engine 110, the manufacture support engine 112, or combinations of both.

The processing capability of the systems, devices, and engines described herein, including the quantum model engine 110 and the manufacture support engine 112, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
generating a quantum computing model to represent an electronic design automation (EDA) process for a circuit design, wherein:
the EDA process comprises a multi-patterning process to assign colors to geometric elements of the circuit design;
the quantum computing model comprises an objective function that specifies a cost value for a given state of the quantum computing model, and wherein generating the quantum computing model comprises adaptively determining a penalty term in the objective function based on a circuit analysis of the circuit design; and
generating a color assignment for the geometric elements of the circuit design through the quantum computing model; and
using the color assignment to support manufacture of circuit layers of the circuit design through multiple manufacturing steps.

2. The method of claim 1, wherein adaptively determining a penalty term in the objective function based on a circuit analysis of the circuit design comprises:
identifying a given geometric element in the circuit design with a highest number of coloring constraints to other geometric elements in the circuit design; and
setting the penalty term in the objective function to be proportional to the highest number of coloring constraints for the given geometric element.

3. The method of claim 1, wherein adaptively determining a penalty term in the objective function based on a circuit analysis of the circuit design comprises:
relaxing at least some coloring constraints of the multi-patterning process;
computing an output for the relaxed multi-patterning process on the circuit design; and
setting the penalty term in the objective function to be proportional to a number of constraint violations in the computed output for the relaxed multi-patterning process on the circuit design.

4. The method of claim 1, wherein the EDA process comprises a triple-patterning process and wherein adaptively determining a penalty term in the objective function based on a circuit analysis of the circuit design comprises:
performing, as the circuit analysis, a double-patterning process on the circuit design;
determining a number of constraint violations in an output of the double-patterning process; and
setting the penalty term in the objective function to be proportional to the number of constraint violations in the output of the double-patterning process on the circuit design.

5. The method of claim 1, wherein the adaptively determined penalty term suppresses some, but not all, non-physical states from occurring in the quantum computing model, wherein the non-physical states correspond to outputs to the multi-patterning process that represent prohibited solutions of the multi-patterning process.

6. The method of claim 5, wherein the prohibited solutions of the multi-patterning process comprise outputs in which a geometric element is assigned more than one color, a geometric element is assigned no color, or combinations of both.

7. The method of claim 1, wherein generating the color assignment comprises determining a ground state with a minimum cost value for the quantum computing model through quantum annealing.

8. A system comprising:
a quantum model engine configured to:
generate a quantum computing model to represent an electronic design automation (EDA) process for a circuit design, wherein:
the EDA process comprises a multi-patterning process to assign colors to geometric elements of the circuit design;
the quantum computing model comprises an objective function that specifies a cost value for a given state of the quantum computing model, and wherein generating the quantum computing model comprises adaptively determining a penalty term in the objective function based on a circuit analysis of the circuit design; and
generate a color assignment for the geometric elements of the circuit design through the quantum computing model; and
a manufacture support engine configured to use the color assignment to support manufacture of circuit layers of the circuit design through multiple manufacturing steps.

9. The system of claim 8, wherein the quantum model engine is configured to adaptively determine a penalty term in the objective function based on a circuit analysis of the circuit design by:
identifying a given geometric element in the circuit design with a highest number of coloring constraints to other geometric elements in the circuit design; and
setting the penalty term in the objective function to be proportional to the highest number of coloring constraints for the given geometric element.

10. The system of claim 8, wherein the quantum model engine is configured to adaptively determine a penalty term in the objective function based on a circuit analysis of the circuit design by:
relaxing at least some coloring constraints of the multi-patterning process;
computing an output for the relaxed multi-patterning process on the circuit design; and
setting the penalty term in the objective function to be proportional to a number of constraint violations in the computed output for the relaxed multi-patterning process on the circuit design.

11. The system of claim 8, wherein the EDA process comprises a triple-patterning process and wherein the quantum model engine is configured to adaptively determine a penalty term in the objective function based on a circuit analysis of the circuit design by:
performing, as the circuit analysis, a double-patterning process on the circuit design;
determining a number of constraint violations in an output of the double-patterning process; and
setting the penalty term in the objective function to be proportional to the number of constraint violations in the output of the double-patterning process on the circuit design.

12. The system of claim 8, wherein the adaptively determined penalty term suppresses some, but not all, non-physical states from occurring in the quantum computing model, wherein the non-physical states correspond to outputs to the multi-patterning process that represent prohibited solutions of the multi-patterning process.

13. The system of claim 12, wherein the prohibited solutions of the multi-patterning process comprise outputs in which a geometric element is assigned more than one color, a geometric element is assigned no color, or combinations of both.

14. The system of claim 8, wherein the quantum model engine is configured to generate the color assignment comprises determining a ground state with a minimum cost value for the quantum computing model through quantum annealing.

15. A non-transitory machine-readable medium comprising instructions that, when executed by a processor, cause a computing system to:
generate a quantum computing model to represent an electronic design automation (EDA) process for a circuit design, wherein:
the EDA process comprises a multi-patterning process to assign colors to geometric elements of the circuit design;
the quantum computing model comprises an objective function that specifies a cost value for a given state of the quantum computing model, and wherein generating the quantum computing model comprises adaptively determining a penalty term in the objective function based on a circuit analysis of the circuit design; and
generate a color assignment for the geometric elements of the circuit design through the quantum computing model; and
use the color assignment to support manufacture of circuit layers of the circuit design through multiple manufacturing steps.

16. The non-transitory machine-readable medium of claim 15, wherein the instructions to adaptively determine a penalty term in the objective function based on a circuit analysis of the circuit design comprise instructions to:
identify a given geometric element in the circuit design with a highest number of coloring constraints to other geometric elements in the circuit design; and
set the penalty term in the objective function to be proportional to the highest number of coloring constraints for the given geometric element.

17. The non-transitory machine-readable medium of claim 15, wherein the instructions to adaptively determine a penalty term in the objective function based on a circuit analysis of the circuit design comprise instructions to:
relax at least some coloring constraints of the multi-patterning process;
compute an output for the relaxed multi-patterning process on the circuit design; and
set the penalty term in the objective function to be proportional to a number of constraint violations in the computed output for the relaxed multi-patterning process on the circuit design.

18. The non-transitory machine-readable medium of claim 15, wherein the EDA process comprises a triple-patterning process and wherein the instructions to adaptively determining a penalty term in the objective function based on a circuit analysis of the circuit design comprise instructions to:
perform, as the circuit analysis, a double-patterning process on the circuit design;
determine a number of constraint violations in an output of the double-patterning process; and
set the penalty term in the objective function to be proportional to the number of constraint violations in the output of the double-patterning process on the circuit design.

19. The non-transitory machine-readable medium of claim 15, wherein the adaptively determined penalty term suppresses some, but not all, non-physical states from occurring in the quantum computing model, wherein the non-physical states correspond to outputs to the multi-patterning process that represent prohibited solutions of the multi-patterning process; and
wherein the prohibited solutions of the multi-patterning process comprise outputs in which a geometric element is assigned more than one color, a geometric element is assigned no color, or combinations of both.

20. The non-transitory machine-readable medium of claim 15, wherein the instructions to generate the color assignment comprise instructions to determine a ground state with a minimum cost value for the quantum computing model through quantum annealing.
